(19) United States
(12) Patent Application Publication
(10) Pub. No.: US 2025/0337708 A1
(43) Pub. Date: Oct. 30, 2025

(54) METHOD, APPARATUS, DEVICE, AND STORAGE MEDIUM FOR MESSAGE INTERACTION

(71) Applicant: Beijing Zitiao Network Technology Co., Ltd., Beijing (CN)

(72) Inventors: Jiahui Yang, Beijing (CN); Xiaoxue Zhang, Beijing (CN)

(21) Appl. No.: 19/192,817

(22) Filed: Apr. 29, 2025

Related U.S. Application Data
(63) Continuation of application No. PCT/CN2024/089919, filed on Apr. 25, 2024.

(51) Int. Cl. H04L 51/56; G06F 3/0484

(52) U.S. Cl. CPC H04L 51/56; G06F 3/0484

(57) ABSTRACT

According to embodiments of the disclosure, a method, an apparatus, a device and a storage medium for message interaction are provided. The method includes: displaying a group of visual elements in a live streaming interface of a live streaming room, the group of visual elements corresponding to a group of users participating in an interactive activity of the live streaming room; and during the interactive activity, based on interactive information about the group of users within a first period of the process, adjusting display positions of the group of visual elements in the live streaming interface to represent an association between the interactive information about the group of users in the first period. Embodiments of the disclosure may effectively improve the efficiency of information interaction based on different applications or based on different types of clients.

### CROSS-REFERENCE

This application claims the benefit of International Patent Application No. PCT/CN2024/089919 filed on Apr. 25, 2024, entitled “METHOD, APPARATUS, DEVICE AND STORAGE MEDIUM FOR MESSAGE INTERACTION”, which is hereby incorporated by reference in its entirety.

### FIELD

Example embodiments of the present disclosure generally relate to the field of computers, and in particular, to a method, an apparatus, a device, and a computer-readable storage medium for message interaction.

### BACKGROUND

With rapid development of intellectualization, various forms of electronic devices can greatly enrich people's daily lives. For example, a user may perform message interaction with other users based on various electronic devices. How to improve the efficiency of managing information interaction of the user with other users based on various electronic devices is a focus problem concerned.

### SUMMARY

In a first aspect of the present disclosure, a method for message interaction is provided. The method includes: in response to receiving a request to view message, displaying a viewing interface for a target session in a first application, the target session associated at least with a first user and a second user; obtaining at least one message from the second user by accessing a target data set, the target data set associated at least with the first application and at least one other application different from the first application; obtaining a first attribute of a first message in the at least one message, the first attribute indicating a first sending means for the second user to send the first message; and displaying the first message in the viewing interface according to a first display style corresponding to the first attribute.

In a second aspect of the present disclosure, an apparatus for message interaction is provided. The apparatus includes: a first displaying module configured to, in response to receiving a request to view message, display a viewing interface of a target session in a first application, the target session associated with at least a first user and a second user; a first acquisition module configured to acquire at least one message from the second user by accessing a target data set, the target data set associated with at least the first application and at least one other application different from the first application; a second obtaining module configured to obtain a first attribute of a first message in the at least one message, the first attribute indicating a first sending means for the second user to send the first message; and a second displaying module configured to display the first message on the viewing interface according to a first display style corresponding to the first attribute.

In a third aspect of the present disclosure, there is provided an electronic device, the device including at least one processing unit; and at least one memory coupled to the at least one processing unit and storing instructions for execution by the at least one processing unit. The instructions, when executed by the at least one processing unit, cause the device to perform the method of the first aspect.

In a fourth aspect of the present disclosure, a computer readable storage medium is provided, where the computer readable storage medium stores a computer program thereon, and the computer program is executable by a processor to implement the method of the first aspect.

It should be appreciated that what is described in this section is not intended to limit critical features or essential features of embodiments of the present disclosure, nor is it intended to limit the scope of the present disclosure. Other features of the present disclosure will be readily appreciated from the following description.

### BRIEF DESCRIPTION OF THE DRAWINGS

The above and other features, advantages, and aspects of various embodiments of the present disclosure will become more apparent with reference to the following detailed description taken in conjunction with the accompanying drawings. In the drawings, the same or similar reference signs denote the same or similar elements, where:

FIG. 1 illustrates a schematic diagram of an example environment in which embodiments of the present disclosure can be implemented;

FIGS. 2-3 illustrate schematic diagrams of example interfaces according to some embodiments of the present disclosure;

FIG. 4 illustrates a flowchart of a process for message interaction according to some embodiments of the disclosure;

FIG. 5 shows a schematic structural block diagram of an apparatus for message interaction according to some embodiments of the present disclosure;

FIG. 6 illustrates a block diagram of an electronic device capable of implementing various embodiments of the present disclosure.

### DETAILED DESCRIPTION

Embodiments of the present disclosure will be described in more detail below with reference to the accompanying drawings. Although certain embodiments of the present disclosure are shown in the drawings, it should be understood that the present disclosure may be implemented in various forms and should not be construed as limited to the embodiments set forth herein, but rather, these embodiments are provided for a thorough and complete understanding of this present disclosure. It should be understood that the drawings and embodiments of the present disclosure are for illustrative purposes only and are not intended to limit the scope of the present disclosure.

It is important to note that heading of any section/subsection provided in this article is not limiting. Various embodiments are described throughout herein, and any type of embodiments can be included under any section/subsection. Furthermore, the embodiments described in any section/subsection may be combined in any way with any other embodiments described in the same section/subsection and/or in a different section/subsection.

In the description of embodiments of the present disclosure, the term “including” and similar expressions shall be understood as an open-ended inclusion, that is, “including but not limited to”. The term “based on” should be understood to mean “based at least in part on.” The term “an embodiment” or “the embodiment” shall be understood to mean “at least one embodiment”. The term “some embodiments” should be understood as “at least some embodiments”. Other explicit and implicit definitions may be included below. The terms “first”, “second”, etc. may refer to different or the same user. Other explicit and implicit definitions may be included below.

The embodiments of the present disclosure may involve user data, the obtaining and/or use of data, etc. These aspects comply with corresponding laws, regulations and relevant regulations. In the embodiments of this disclosure, collection, obtaining, processing, processing, forwarding, use, etc. of all data are performed with the user's knowledge and confirmation. Accordingly, when implementing each embodiment of the present disclosure, users should be informed of the type, scope of use, usage scenarios, etc. that may be involved in the data or information and obtain their authorization through appropriate means in accordance with relevant laws and regulations. The specific notification and/or authorization methods may vary according to the actual situation and application scenarios, and the scope of the present disclosure is not limited in this regard.

The technical solution in this specification and embodiments, if the processing of personal information is involved, the processing will be carried out on the premise that there is a basis of legality (e.g., consent of the subject of the personal information is obtained or it is necessary to fulfill a contract, etc.), and the processing will be carried out only within the scope of the stipulations or agreements. The user refusing to process personal information other than that which is necessary for the basic functions will not affect the user's use of the basic functions.

Embodiments of the present disclosure provide a solution for message interaction. According to the solution, in response to receiving a request to view message, a viewing interface for a target session can be displayed in a first application, the target session associated at least with a first user and a second user; at least one message from a second user is obtained by accessing a target data set, the target data set associated at least with the first application and at least one other application different from the first application; a first attribute of a first message in at least one message is obtained, the first attribute indicating a first sending means for the second user to send the first message; and the first message is displayed in the viewing interface according to the first display style corresponding to the first attribute.

Thus, the embodiments of the present disclosure can separately view, in a viewing page, messages when a user and other users perform information interaction based on different applications and/or based on different types of clients, thereby effectively improving the efficiency of information interaction based on different applications and/or based on different types of clients.

### Example Environment

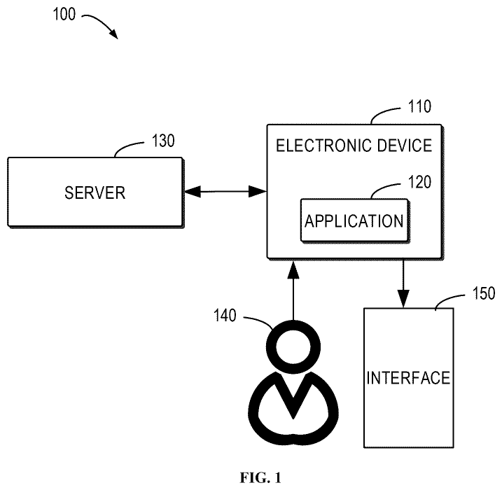

FIG. 1 illustrates a schematic diagram of an example environment 100 in which embodiments of the present disclosure can be implemented. As shown in FIG. 1, example environment 100 may include an electronic device 110.

In this example environment 100, an application 120 that supports interface interaction may run on an electronic device 110. The application 120 may be any suitable type of application for interface interaction, examples of which may include but are not limited to: a video application, or other appropriate applications. The target user 140 may view, based on the application 120 of the electronic device, chat recordings of the target user with other users based on applications other than the applications 120 and/or other types of clients other than the electronic device.

The target user 140 may interact with application 120 via the electronic device 110 and/or its attached devices.

In the environment 100 of FIG. 1, if the application 120 is in an active state, the electronic device 110 may display an interface 150 for supporting interface interaction through the application 120.

In some embodiments, the electronic device 110 communicates with the server 130 to enable provision of services to the application 120. The electronic device 110 may be any type of a mobile terminal, a fixed terminal or a portable terminal, including a mobile phone, a desktop computer, a laptop computer, a notebook computer, a netbook computer, a tablet computer, a media computer, a multimedia tablet, a palmtop computer, a portable game terminal, a VR/AR equipment, a Personal Communication System (PCS) device, a personal navigation device, a Personal Digital Assistant (PDA), an audio/video player, a digital cameras/camcorder, a positioning device, a TV receiver, a radio receiver, an e-book device, a gaming device, or any combination of the foregoing, including accessories and peripherals for these devices or any combination thereof. In some embodiments, the electronic device 110 can also support any type of interface for the target user (such as “wearable” circuitry, etc.).

The server 130 may be an independent physical server, or a server cluster or distributed system consisted of a plurality of physical servers, or a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server such as a mainframe, an edge computing node, a computing device in a cloud environment, or the like. The server 130 may provide background services for the applications 120 in the electronic device 110 that support interface interaction.

A communication connection may be established between the server 130 and the electronic device 110. Communication connections can be established via wired or wireless manner. Communication connections may include but are not limited to Bluetooth connections, mobile network connections, Universal Serial Bus (USB) connections, Wireless Fidelity (WIFI) connections, etc. The embodiments of the present disclosure are not limited in this regard. In the embodiments of the present disclosure, the server 130 and the electronic device 110 can implement signaling interaction through the communication connection therebetween.

It should be understood that the structure and function of various elements in environment 100 are described for illustrative purposes only and do not imply any limitation on the scope of the present disclosure.

Some example embodiments of the present disclosure will continue to be described below with reference to the accompanying drawings.

### Example Interactions

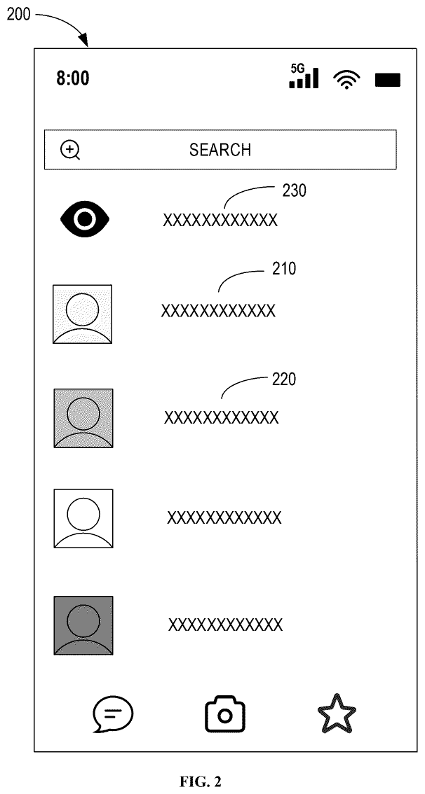

Example interaction processes according to embodiments of the present disclosure will be described below with reference to FIGS. 2-3. FIGS. 2-3 illustrate example interface 200 to interface 300 in accordance with some embodiments of the present disclosure, and the interface 200 to the interface 300 may be provided by the electronic device 110 shown in FIG. 1.

As shown in FIG. 2, the electronic device may provide an interface 200, and the interface 200 may include chat entries of a target user with various users presented based on the application 120 of the electronic device, such as a chat entry 210 with user 1, a chat entry 220 with user 2, and so on, so as to support the target user to select a user in this application 120 to chat with.

In some embodiments, the interface 200 may also include an entry 230 for supporting a target user to view messages of various attributes sent by other users based on various sending means, where the attribute is configured for indicating at least one of the following: an application from which the message is sent and a client version of the application from which the message is sent. That is, the entry 230 is configured to support the target user to view a chat history with respective users based on client versions of the application other than the client version corresponding to the electronic device. The other client versions may be any other suitable types of client versions except for the version on the electronic device. For example, if the electronic device is a smart terminal version, the other client versions may be a tablet version, a computer version, a smart watch version, and so on. The application of this other client version may be an application that is the same as the application 120 on the electronic device but is downloaded at a terminal of a different client version, or it may also be an application that is different from the application 120 on the electronic device and is downloaded at a terminal of a different client version. In some embodiments, the target user may be referred to as the first user and any other user may be referred to as the second user. The application 120 may be a first application and the other applications may be other applications different from the first application.

As an example, upon a user clicking on the entry 230, the application 120 may display a chat entry of the target user with at least one other user. The user may click on a chat entry with a target other user, and at this time, the electronic device may receive a message viewing request. In response to receiving the message viewing request, the electronic device may display an interface 300 (the target session) shown in FIG. 3 in the application 120. The target session is at least associated with the target user and the selected target other users. In some embodiments, the target other users may be one or more, that is to say, the selected chat entry may be a private chat entry or a group chat entry.

The electronic device may obtain at least one message from the target other user by calling the target data set. The target data set is at least associated with a first application and at least one other application different from the first application, i. e. a target database stores historical chat history of a target user with the target other user based on the application 120 and other applications than the application 120, and the at least one message includes messages sent by the target other users based on various applications. Using FIG. 3 as an example, the electronic device can set a message 310 from application 1 of the tablet, a message 320 from application 2 of the computer, and so on.

In some embodiments, the electronic device may set different display styles in the viewing interface for messages in at least one message with different attributes, so as to distinguish the sending means to correspond to respective messages in the at least one message.

In some embodiments, the electronic device can set different display styles for the first message and the second message in the at least one message. It should be noted that the first message and the second message are only used to distinguish to correspond to different attributes, and the attributes indicate sending means for a target other user to send a message.

In some embodiments, the electronic device can obtain a first attribute of the first message and a second attribute of the second message in at least the first piece of information. The electronic device may display the first message in the viewing interface according to a first display style corresponding to the first attribute, and display the second message in the viewing interface according to a second display style corresponding to the second attribute.

In some embodiments, the first display style and the second display style respectively corresponding to the first message and the second message can be determined by an electronic device based on configuration information, wherein the configuration information includes predetermined configuration information, or the configuration information is determined based at least in part on a configuration operation of a user. The configuration information indicates different display styles corresponding to different sending means for the message. As an example, the electronic device may be predetermined with configuration information such as a message sent by a tablet-based application corresponding to a white message bubble, and a message sent by a computer-based application corresponding to a red message bubble, and the like.

It should be noted that, before displaying the first message according to the first display style, the electronic device may also determine whether a predetermined configuration item is enabled. In response to the predetermined configuration item enabled, the electronic device may display the first message according to the first display style. In response to the predetermined configuration item not enabled, the electronic device may not display the first message and the second message based on different display styles, that is, the first message is displayed based on a predetermined display style.

In some embodiments, the electronic device can set different display styles for the message bubble corresponding to the first message and the message bubble corresponding to the second message. As an example, the electronic device can set message bubbles of different color for the first message and the second message. As another example, message bubbles of different shapes may be set for the first message and the second message, etc. For example, the message bubble for the first message corresponding to the application 1 from the tablet may be set to red, and the message bubble for the second message corresponding to the application 2 from the computer may be set to green, and so on.

In some embodiments, the electronic device can display description information of the first message in the viewing interface, the description information at least indicating a sending means for the first message. As an example, the electronic device may display, in the viewing interface, an identifier corresponding to the sending means for the first message. For example, the electronic device may set an identifier corresponding to the message 310 from the tablet as identifier 1, and the electronic device may set an identifier corresponding to the message 320 from the computer as identifier 2, and so on. The description information for the first message displayed in interface 300 may be displayed at any suitable location associated with the first message, such as above the first message, below the first message, and so forth.

In some embodiments, in response to the target client corresponding to the first sending means not installed, the electronic device may further provide, in the interface 300, an obtaining entry for obtaining the target client in association with the description information. For example, if the interface 300 displays a message 320 of a target user with user 1 based on the application 2 on the computer, but the application 1 is not installed locally on the electronic device 110, an entry 330 for obtaining the application 2 may be displayed in interface 300.

Thus, the embodiments of the present disclosure can distinguishingly view messages when a user and other users perform information interaction based on different applications and/or based on different types of clients in a view page, thereby effectively improving the efficiency of information interaction based on different applications or based on different types of clients.

### Example Process

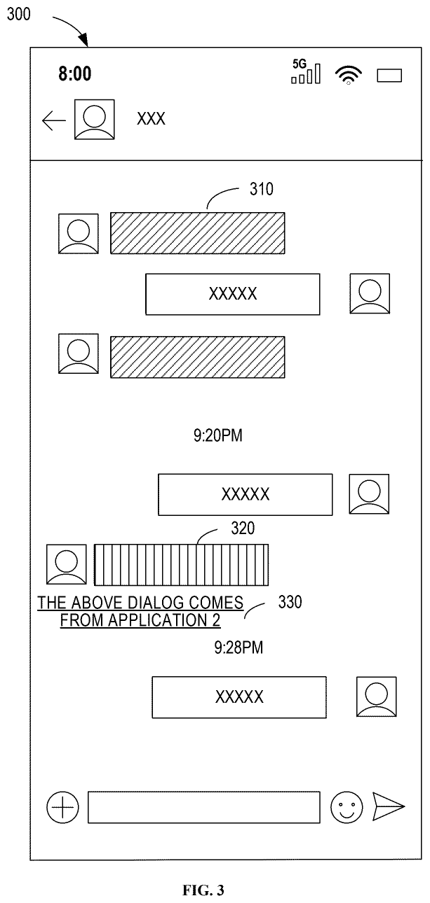

FIG. 4 shows a flowchart of a process 400 for message interaction according to some embodiments of the disclosure. The process 400 may be implemented at an electronic device 110. The process 400 is described below with reference to FIG. 1.

At block 410, in response to receiving a request to view message, a viewing interface for a target session is displayed in a first application, the target session associated at least with a first user and a second user.

At block 420, at least one message is obtained from the second user by calling the target data set, the target data set associated at least with the first application and at least one other application different from the first application.

At block 430, a first attribute of a first message in the at least one message is obtained, the first attribute indicating a first sending means for the second user to send the first message.

At block 440, the first message is displayed in the viewing interface according to a first display style corresponding to the first attribute.

In some embodiments, the first attribute indicates at least one of: an application from which the first message is sent; a client version of the application from which the first message is sent.

In some embodiments, the process 400 further includes determining a first display style corresponding to the first attribute based on the configuration information, where the configuration information includes predetermined configuration information, or the configuration information is determined based at least in part on a configuration operation of the user.

In some embodiments, the configuration information indicates different display styles that correspond to different sending means of the message.

In some embodiments, the process 400 further includes: obtaining a second attribute of a second message in the at least one message, the second attribute indicating a second sending means for the second user to send the second message, the second sending means different from the first sending means; determining a second display style corresponding to the second attribute based on the configuration information; and displaying the second message in the viewing interface according to the second display style corresponding to the second attribute.

In some embodiments, displaying the first message in the viewing interface according to the first display style corresponding to the first attribute includes: determining whether a predetermined configuration item is enabled; and in response to the predetermined configuration item enabled, displaying the first message according to the first display style.

In some embodiments, the process 400 further includes in response to the predetermined configuration item not enabled, displaying the first message according to a predetermined display style.

In some embodiments, the process 400 further includes displaying, in the viewing interface, description information of the first message, the description information at least indicating the first sending means for the first message.

In some embodiments, the process 400 further includes, in response to a target client corresponding to the first sending means not installed, providing, in association with the description information, an obtaining entry for obtaining the target client.

In some embodiments, the first display style indicates at least a color of a message bubble for displaying the first message.

### Example Apparatus and Device

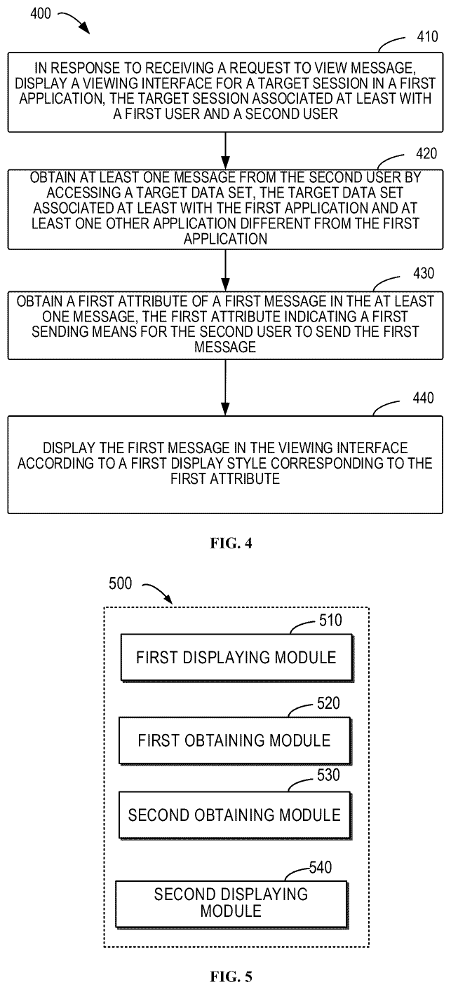

Embodiments of the present disclosure also provide corresponding apparatus for implementing the method or process described above. FIG. 5 illustrates a schematic structural block diagram of an apparatus 500 for message interaction according to certain embodiments of the present disclosure. The apparatus 500 may be implemented as or included in an electronic device 110 as discussed above. The various modules/components in the apparatus 500 may be implemented by hardware, software, firmware, or any combination thereof.

As shown in FIG. 5, the apparatus 500 includes a first displaying module 510 configured to, in response to receiving a request to view message, display a viewing interface of a target session in a first application, the target session associated with at least a first user and a second user; a first obtaining module 520 configured to obtain at least one message from the second user by accessing a target data set, the target data set associated with at least the first application and at least one other application different from the first application; a second obtaining module 530 configured to obtain a first attribute of a first message in the at least one message, the first attribute indicating a first sending means for the second user to send the first message; and a second displaying module 540 configured to display the first message on the viewing interface according to a first display style corresponding to the first attribute.

In some embodiments, the first attribute indicates at least one of: an application from which the first message is sent; a client version of the application from which the first message is sent.

In some embodiments, the apparatus 500 further includes a first determining module configured to determine the first display style corresponding to the first attribute based on configuration information, wherein the configuration information includes predetermined configuration information, or the configuration information is determined based at least in part on a configuration operation of a user.

In some embodiments, the configuration information indicates different display styles that correspond to different sending means for messages.

In some embodiments, the apparatus 500 further includes a third obtaining module configured to obtain a second attribute of a second message in the at least one message, the second attribute indicating a second sending means for the second user to send the second message, the second sending means different from the first sending means; a second determining module configured to determine a second display style corresponding to the second attribute based on the configuration information; and a third displaying module configured to display the second message in the viewing interface according to the second display style corresponding to the second attribute.

In some embodiments, the second displaying module is specifically configured to determine whether the predetermined configuration item is enabled; and display the first message according to the first display style in response to the predetermined configuration item enabled.

In some embodiments, the apparatus 500 further includes a fourth displaying module configured to display, in response to the predetermined configuration item not enabled, displaying the first message according to a predetermined display style.

In some embodiments, the apparatus 500 further includes a fifth displaying module configured to display description information of the first message in the viewing interface, the description information at least indicating a first sending means for the first message.

In some embodiments, the apparatus 500 further includes a providing module configured to provide, in association with the description information, an obtaining entry for obtaining the target client, in response to a target client corresponding to the first sending means not installed.

In some embodiments, the first display style indicates at least a color of a message bubble for displaying the first message.

The units included in the apparatus 500 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the units in the apparatus 500 may be implemented, at least in part, by one or more hardware logic components. By way of example and not limitation, exemplary types of hardware logic components that may be used include field programmable gate arrays (FPGAs), application specific integrated circuits (ASICs), application specific standard products (ASSPs), system-on-chip (SOCs), complex programmable logic devices (CPLDs), and the like.

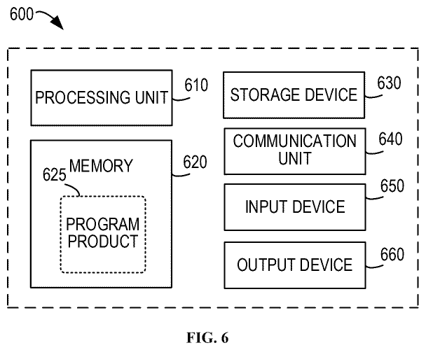

FIG. 6 illustrates a block diagram of an electronic device 600 in which one or more embodiments of the present disclosure may be implemented. It should be understood that the electronic device 600 illustrated in FIG. 6 is merely exemplary and should not constitute any limitation on the functionality and scope of the embodiments described herein. The electronic device shown in FIG. 6 may be used to implement the electronic device 110 shown in FIG. 1.

As shown in FIG. 6, the electronic device 600 is in the form of a general-purpose electronic device. Components of the electronic device 600 may include, but are not limited to, one or more processors or processing units 610, a memory 620, a storage device 630, one or more communication units 640, one or more input devices 650, and one or more output devices 660. The processing unit 610 may be an actual or virtual processor and capable of performing various processes according to programs stored in the memory 620. In multiprocessor systems, multiple processing units execute computer-executable instructions in parallel to improve the parallel processing capability of electronic device 600.

The electronic device 600 typically includes a plurality of computer storage media. Such media may be any available media accessible by the electronic device 600, including, but not limited to, volatile and non-volatile media, removable and non-removable media. The memory 620 may be a volatile memory (e.g., a register, a cache, a random-access memory (RAM)), a non-volatile memory (e.g., read-only memory (ROM), an electrically erasable programmable read-only memory (EEPROM), flash memory), or some combination thereof. A storage device 630 may be a removable or non-removable medium and may include a machine-readable medium, such as a flash drive, a magnetic disk, or any other medium, which may be used to store information and/or data (such as training data for training) and may be accessed within the electronic device 600.

The electronic device 600 may further include additional removable/non-removable, volatile/non-volatile storage media. Although not shown in FIG. 6, a disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 620 may include a computer program product 625 having one or more program modules configured to perform various methods or actions of various embodiments of the present disclosure.

The communications unit 640 implements communications with other electronic devices over a communications medium. Additionally, the functionality of components of the electronic device 600 may be implemented in a single computing cluster or a plurality of computing machines capable of communicating over a communication connection. Thus, the electronic device 600 may operate in a networked environment using logical connections to one or more other servers, network personal computers (PCs), or another network node.

The input device 650 may be one or more input devices such as a mouse, a keyboard, a trackball, or the like. The output device 660 may be one or more output devices, such as a display, a speaker, a printer, or the like. The electronic device 600 may also communicate with one or more external devices (not shown) such as a storage device, a display device, or the like through the communication unit 640 as required, and communicate with one or more devices that enable a user to interact with the electronic device 600, or communicate with any device (e. g., a network card, a modem, or the like) that enables the electronic device 600 to communicate with one or more other electronic devices. Such communication may be performed via an input/output (I/O) interface (not shown).

According to exemplary implementations of the present disclosure, there is provided a computer-readable storage medium having computer instructions stored thereon, where the computer instructions are executed by a processor to implement the method described above. In accordance with exemplary implementations of the present disclosure, there is also provided a computer program product, and the computer program product is tangibly stored on a non-transient computer-readable medium and includes computer-executable instructions, and the computer-executable instructions are executed by the processor to implement the above-described method.

Aspects of the present disclosure are described herein with reference to flowcharts and/or block diagrams of methods, apparatuses, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may also be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods, and computer program products according to various implementations of the present disclosure. In this regard, each block in the flowchart or block diagram may represent a module, segment, or portion of instructions which includes one or more executable instructions for implementing the specified logical function(s). In some replaced implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

What is claimed is:

1. A method for message interaction, comprising:
in response to receiving a request to view message, displaying a viewing interface for a target session in a first application, the target session associated at least with a first user and a second user;
obtaining at least one message from the second user by accessing a target data set, the target data set associated at least with the first application and at least one other application different from the first application;
obtaining a first attribute of a first message in the at least one message, the first attribute indicating a first sending means for the second user to send the first message; and
displaying the first message in the viewing interface according to a first display style corresponding to the first attribute.

2. The method of claim 1, wherein the first attribute indicates at least one of:
an application from which the first message is sent; or
a client version of the application from which the first message is sent.

3. The method of claim 1, further comprising:
determining the first display style corresponding to the first attribute based on configuration information, wherein the configuration information comprises predetermined configuration information, or the configuration information is determined based at least in part on a configuration operation of a user.

4. The method of claim 3, wherein the configuration information indicates different display styles corresponding to different sending means for messages.

5. The method of claim 3, further comprising:
obtaining a second attribute of a second message in the at least one message, the second attribute indicating a second sending means for the second user to send the second message, the second sending means different from the first sending means;
determining a second display style corresponding to the second attribute based on the configuration information; and
displaying the second message in the viewing interface according to the second display style corresponding to the second attribute.

6. The method of claim 1, wherein displaying the first message in the viewing interface according to the first display style corresponding to the first attribute comprises:
determining whether a predetermined configuration item is enabled; and
in response to the predetermined configuration item enabled, displaying the first message according to the first display style.

7. The method of claim 6, further comprising:
in response to the predetermined configuration item not enabled, displaying the first message according to a predetermined display style.

8. The method of claim 1, further comprising:
displaying description information of the first message in the viewing interface, the description information indicating at least the first sending means for the first message.

9. The method of claim 8, further comprising:
in response to a target client corresponding to the first sending means not installed, providing, in association with the description information, an obtaining entry for obtaining the target client.

10. The method of claim 1, wherein the first display style indicates at least a color of a message bubble for displaying the first message.

11. An electronic device, comprising:
at least one processing unit; and
at least one memory coupled to the at least one processing unit and storing instructions for execution by the at least one processing unit, the instructions, when executed by the at least one processing unit, cause the electronic device to perform acts comprising:
in response to receiving a request to view message, displaying a viewing interface for a target session in a first application, the target session associated at least with a first user and a second user;
obtaining at least one message from the second user by accessing a target data set, the target data set associated at least with the first application and at least one other application different from the first application;
obtaining a first attribute of a first message in the at least one message, the first attribute indicating a first sending means for the second user to send the first message; and
displaying the first message in the viewing interface according to a first display style corresponding to the first attribute.

12. The electronic device of claim 11, wherein the first attribute indicates at least one of:
an application from which the first message is sent; or
a client version of the application from which the first message is sent.

13. The electronic device of claim 11, wherein the acts further comprise:
determining the first display style corresponding to the first attribute based on configuration information, wherein the configuration information comprises predetermined configuration information, or the configuration information is determined based at least in part on a configuration operation of a user.

14. The electronic device of claim 13, wherein the configuration information indicates different display styles corresponding to different sending means for messages.

15. The electronic device of claim 13, wherein the acts further comprise:
obtaining a second attribute of a second message in the at least one message, the second attribute indicating a second sending means for the second user to send the second message, the second sending means different from the first sending means;
determining a second display style corresponding to the second attribute based on the configuration information; and
displaying the second message in the viewing interface according to the second display style corresponding to the second attribute.

16. The electronic device of claim 1, wherein displaying the first message in the viewing interface according to the first display style corresponding to the first attribute comprises:
determining whether a predetermined configuration item is enabled; and
in response to the predetermined configuration item enabled, displaying the first message according to the first display style.

17. The electronic device of claim 6, wherein the acts further comprise:
in response to the predetermined configuration item not enabled, displaying the first message according to a predetermined display style.

18. The electronic device of claim 11, wherein the acts further comprise:
displaying description information of the first message in the viewing interface, the description information indicating at least the first sending means for the first message.

19. The electronic device of claim 18, wherein the acts further comprise:
in response to a target client corresponding to the first sending means not installed, providing, in association with the description information, an obtaining entry for obtaining the target client.

20. A non-transitory computer readable storage medium having a computer program stored thereon, the computer program, when executed by a processor, implements acts comprising:
in response to receiving a request to view message, displaying a viewing interface for a target session in a first application, the target session associated at least with a first user and a second user;
obtaining at least one message from the second user by accessing a target data set, the target data set associated at least with the first application and at least one other application different from the first application;
obtaining a first attribute of a first message in the at least one message, the first attribute indicating a first sending means for the second user to send the first message; and
displaying the first message in the viewing interface according to a first display style corresponding to the first attribute.
